(19) United States
(12) Patent Application Publication
(10) Pub. No.: US 2016/0084001 A1
(43) Pub. Date: Mar. 24, 2016

(54) LADDER MOUNTABLE ARTICLE HOLDING SYSTEM

(71) Applicant: Jimmy Maloney, Lincoln, IL (US)

(72) Inventor: Jimmy Maloney, Lincoln, IL (US)

(21) Appl. No.: 14/489,982

(22) Filed: Sep. 18, 2014

(51) Int. Cl. E06C 7/14; B65D 25/20

(52) U.S. Cl. CPC E06C 7/14; B65D 25/20

(57) ABSTRACT

A ladder mountable article holding system includes a housing having a bottom wall and a perimeter wall that is attached to and extends upwardly from the bottom wall. The perimeter wall has an upper edge defining an opening into the housing. The perimeter wall includes a front wall, a rear wall, a first side wall and a second side wall. Each of the first and second side walls has one of a pair of side panels attached thereto. Each of the side panels has an upper edge, a lower edge, an inner surface facing the housing and an outer surface facing away from the housing. The lower edges are positioned below a plane of the bottom wall. Each of the outer surfaces has a plurality of pockets attached thereto. A coupler is mounted to the housing and releasably couples the housing to an upper panel of a ladder.

### BACKGROUND OF THE DISCLOSURE

### Field of the Disclosure

The disclosure relates to article holding devices and more particularly pertains to a new article holding device for holding tools, fasteners and the like in a housing on top of a ladder for easy accessibility thereof.

### SUMMARY OF THE DISCLOSURE

An embodiment of the disclosure meets the needs presented above by generally comprising a housing having a bottom wall and a perimeter wall that is attached to and extends upwardly from the bottom wall. The perimeter wall has an upper edge defining an opening into the housing. The perimeter wall includes a front wall, a rear wall, a first side wall and a second side wall. Each of the first and second side walls has one of a pair of side panels attached thereto. Each of the side panels has an upper edge, a lower edge, an inner surface facing the housing and an outer surface facing away from the housing. The lower edges are positioned below a plane of the bottom wall. Each of the outer surfaces has a plurality of pockets attached thereto. A coupler is mounted to the housing and releasably couples the housing to an upper panel of a ladder.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a ladder mountable article holding system according to an embodiment of the disclosure.

FIG. 2 is a top view of an embodiment of the disclosure.

FIG. 3 is a front view of an embodiment of the disclosure.

FIG. 4 is a right side view of an embodiment of the disclosure.

FIG. 5 is a top perspective view of an embodiment of the disclosure.

### DESCRIPTION OF THE PREFERRED EMBODIMENT

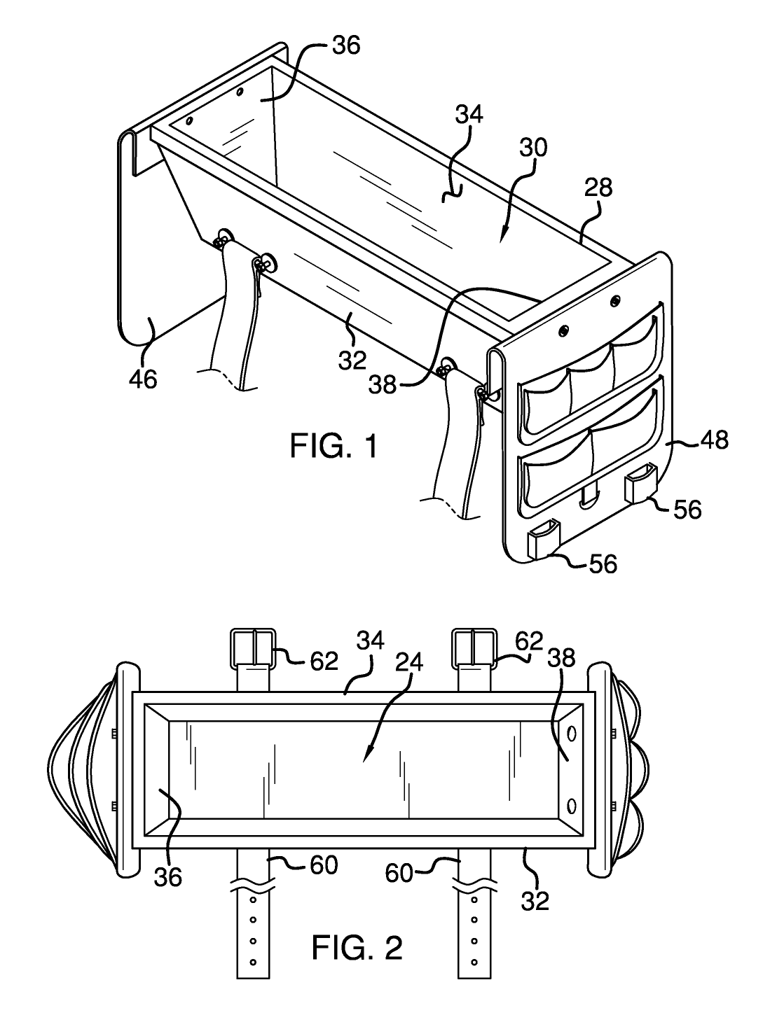

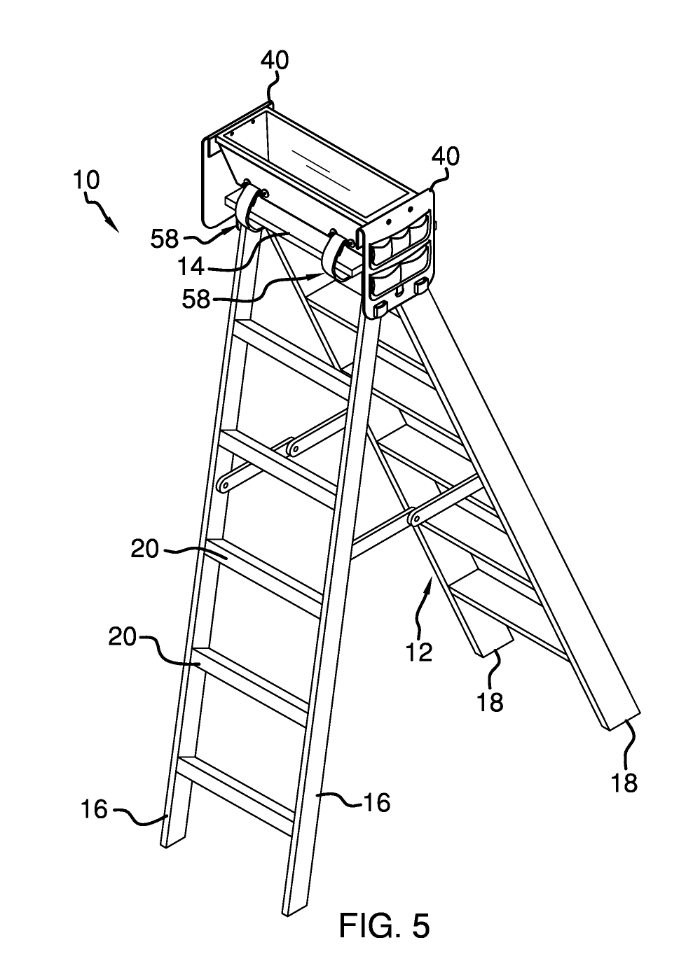

With reference now to the drawings, and in particular to FIGS. 1 through 5 thereof, a new article holding device embodying the principles and concepts of an embodiment of the disclosure and generally designated by the reference numeral 10 will be described.

As best illustrated in FIGS. 1 through 5, the ladder mountable article holding system 10 generally comprises a generally conventional ladder 12 having an upper panel 14 and a pair of legs 16 attached to and extending downwardly from the upper panel 14. A second pair of legs 18 may be provided as well. A plurality of rungs 20 is attached to and extending between the pair of legs 16.

A housing 22 has a bottom wall 24 and a perimeter wall 26 that is attached to and extends upwardly from the bottom wall 24. The perimeter wall 26 has an upper edge 28 defining an opening 30 into the housing 22 and the perimeter wall 26 includes a front wall 32, a rear wall 34, a first side wall 36 and a second side wall 38. The perimeter wall 26 tapers outwardly from the bottom wall 24 to the upper edge 28 of the perimeter wall 26. The upper panel 14 has a width dimension extending between a pair of lateral edges of the upper panel 14. The bottom wall 24 has a width dimension that is approximately equal to the width dimension of the upper panel 14. More particularly, the bottom wall 24 may have a length between about 12.0 inches and 15.0 inches and a width between 4.0 inches and 6.0 inches. The perimeter wall 26 has a height less than about 5.0 inches and may have a height less than 4.0 inches such that a depth of the housing 22 is less than about 4.0 inches.

A pair of side panels 40 is provided. Each of the side panels 40 is attached to one of the first 36 and second 38 side walls. The side panels 40 each have an upper edge 42, a lower edge 44, an inner surface 46 facing the housing 22 and an outer surface 48 facing away from the housing 22. The lower edges 44 are positioned below a plane of the bottom wall 24 such that the side panels 40 each extend below the upper panel 14. Thus, the low profile of the housing 22 and along with the side panels 40 positioned outside and extending below the lateral edges of the upper panel 14 combine to form a device that is very stable relative to the upper panel 14. The side panels 40 may be comprised of a flexible material such as canvas, an elastomer, leather or the like.

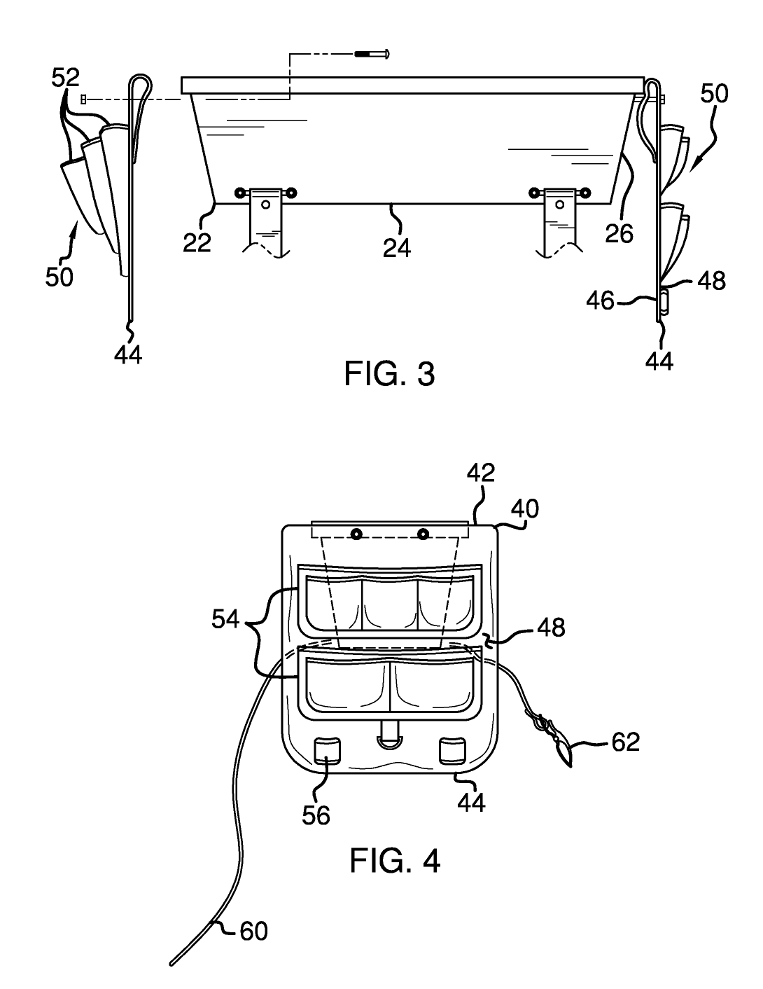

A plurality of pockets 50 is also provided. Each of the outer surfaces 48 has multiple ones of the pockets 50 attached thereto. As can be seen in FIG. 3, the pockets 50 may be stacked pockets 52 positioned on top of each other or spaced pockets 54 that are vertically and laterally spaced from each other. Additionally, sleeves 56 may be positioned on the side panels 40 for elongated tools such as screwdrivers, for instance, extended therethrough.

A coupler 58 is mounted to the housing 22 and releasably couples the housing 22 to the upper panel 14. The coupler 58 includes a first mating member 60 attached to the front wall 32 and a second mating member 62 attached to the rear wall 34. The first mating member 60 may comprise a belt and the second mating member 62 may comprise a buckle. The belt, or first mating member 60, is extended under the upper panel 14 and engaged with the buckle, or second mating member 62, to retain the housing 22 on the upper panel 14. The coupler 58, as shown in FIG. 1, may include a pair of couplers 58 which are spaced from each other laterally to prevent twisting of the housing 22 on the upper panel 14.

In use, the housing 22 is positioned on the upper panel 14 and secured in place with the coupler(s) 58. The housing 22 may be filled with useful articles either before or after attachment to the upper panel 14. The useful articles may include, for instance, hand tools, fasteners, paint brushed and the like. The pockets 50 may also be used for these types of articles as well so that the user will have these articles readily at hand while performing work.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An article holding system including:
a ladder having an upper panel, a pair of legs being attached to and extending downwardly from said upper panel, a plurality of rungs being attached to and extending between said pair of legs;
a housing having a bottom wall and a perimeter wall being attached to and extending upwardly from said bottom wall, said perimeter wall having an upper edge defining an opening into said housing, said perimeter wall including a front wall, a rear wall, a first side wall and a second side wall said perimeter wall tapering outwardly from said bottom wall to said upper edge of said perimeter wall;
a pair of side panels, each of said side panels being attached to one of said first and second side walls, each of said side panels having an upper edge, a lower edge, an inner surface facing said housing and an outer surface facing away from said housing, said lower edges being positioned below a plane of said bottom wall such that said side panels each extend below said upper panel;
a plurality of pockets, each of said outer surfaces having multiple ones of said pockets attached thereto; and
a coupler being mounted to said housing and releasably coupling said housing to said upper panel.

2. (canceled)

3. The article holding system according to claim 1, wherein said upper panel has a width dimension extending between a pair of lateral edges of said upper panel, said bottom wall having a width dimension being approximately equal to said width dimension of said upper panel.

4. The article holding system according to claim 1, wherein said coupler includes a first mating member attached to said front wall and a second mating member attached to said rear wall.

5. The article holding system according to claim 4, wherein said first mating member comprises a belt and said second mating member comprising a buckle, said belt extending under said upper panel and engaging said buckle.

6. The article holding system according to claim 5, wherein said coupler comprises a pair of couplers laterally spaced from each other.

7. An article holding device configured for positioning on an upper panel of a ladder, said device including:
a housing having a bottom wall and a perimeter wall being attached to and extending upwardly from said bottom wall, said perimeter wall having an upper edge defining an opening into said housing, said perimeter wall including a front wall, a rear wall, a first side wall and a second side wall said perimeter wall tapering outwardly from said bottom wall to said upper edge of said perimeter wall;
a pair of side panels, each of said side panels being attached to one of said first and second side walls, each of said side panels having an upper edge, a lower edge, an inner surface facing said housing and an outer surface facing away from said housing, said lower edges being positioned below a plane of said bottom wall;
a plurality of pockets, each of said outer surfaces having multiple ones of said pockets attached thereto; and
a coupler being mounted to said housing and configured for releasably coupling said housing to said upper panel.

8. (canceled)

9. The article holding system according to claim 7, wherein said coupler includes a first mating member attached to said front wall and a second mating member attached to said rear wall.

10. The article holding system according to claim 7, wherein said first mating member comprises a belt and said second mating member comprising a buckle, said belt configured for extending under said upper panel and engaging said buckle.

11. The article holding system according to claim 10, wherein said coupler comprises a pair of couplers laterally spaced from each other.

12. An article holding system including:
a ladder having an upper panel, a pair of legs being attached to and extending downwardly from said upper panel, a plurality of rungs being attached to and extending between said pair of legs;
a housing having a bottom wall and a perimeter wall being attached to and extending upwardly from said bottom wall, said perimeter wall having an upper edge defining an opening into said housing, said perimeter wall including a front wall, a rear wall, a first side wall and a second side wall, said perimeter wall tapering outwardly from said bottom wall to said upper edge of said perimeter wall;
said upper panel having a width dimension extending between a pair of lateral edges of said upper panel, said bottom wall having a width dimension being approximately equal to said width dimension of said upper panel;
a pair of side panels, each of said side panels being attached to one of said first and second side walls, each of said side panels having an upper edge, a lower edge, an inner surface facing said housing and an outer surface facing away from said housing, said lower edges being positioned below a plane of said bottom wall such that said side panels each extend below said upper panel, said side panels being flexible;
a plurality of pockets, each of said outer surfaces having multiple ones of said pockets attached thereto; and
a coupler being mounted to said housing and releasably coupling said housing to said upper panel, said coupler including a first mating member attached to said front wall and a second mating member attached to said rear wall, said first mating member comprising a belt and said second mating member comprising a buckle, said belt extending under said upper panel and engaging said buckle.
